(19) United States
(12) Patent Application Publication
(10) Pub. No.: US 2014/0089013 A1
(43) Pub. Date: Mar. 27, 2014

(54) SYSTEM AND METHOD FOR SYNCHRONIZING AGGREGATE FINANCIAL DATA WITH DETAILED DATA

(71) Applicant: HARTFORD FIRE INSURANCE COMPANY, Hartford, CT (US)

(72) Inventor: Amarjit Singh Saimbi, Harleysville, PA (US)

(73) Assignee: HARTFORD FIRE INSURANCE COMPANY, Hartford, CT (US)

(21) Appl. No.: 13/628,965

(22) Filed: Sep. 27, 2012

(51) Int. Cl. G06Q 40/08

(52) U.S. Cl. 705/4

(57) ABSTRACT

Systems, methods, and computer readable media suited for data recordation in processing at least one insurance claim or financial services transaction. During a predetermined time period, there is received, from a user-accessible device, via a computer communications network, a data entry for addition to a transient data table, with relation to at least one insurance claim or financial services transaction. Further, there is received at least one additional data entry for addition to the transient data table. Via a processor, the data entries are aggregated over the predetermined time period. Further, the aggregated data are frozen and recorded upon expiration of the predetermined time period. Additionally, the aggregated data are outputted for viewing upon expiration of the predetermined time period. Also, there are repeated, at least once and over an additional predetermined time period, the receipt and aggregation of data entries and the freezing, recordation and outputting of aggregated data.

### BACKGROUND OF THE INVENTION

Financial concerns and organizations, such as insurance companies, assimilate tremendous amounts of data in connection with various activities, such as the processing of insurance claims. Techniques to aggregate data have therefore become tremendously important in such concerns and organizations, at the very least to enhance efficiency in data processing and storage.

In that context and others data aggregation is used commonly in reporting to improve query performance. To the extent that data are stored in rows and columns (e.g., in a spreadsheet format or other format conducive to such storage), detailed data are grouped and stored at a defined level to reduce the number of data rows that are queried. If the aggregation is synchronized with changes to the detailed data, then drilling-down, that is, proceeding from an aggregate fact table (which can be considered to be summary information) to its detail becomes accurate. In data warehousing, a “fact table” includes measurements, metrics or facts about a business.

However, in financial reporting in the insurance industry and elsewhere, where aggregate data may need to be frozen for a given period of time, detailed data continues to change and evolve on a daily basis and the drill-down from aggregate facts to details does not yield the same results. Conventionally, this problem has been addressed by backing up, in separate tables, the detailed data that corresponds to (i.e., that has combined to form) the aggregate data. This has the undesirable result of increasing complexity for reporting, where intricate yet inefficient solutions need to be implemented to facilitate drill-down, while a large number of additional tables need to be managed, with a resultant increase in overhead.

### SUMMARY OF THE INVENTION

According to one aspect, the invention relates to a computer system for data recordation in processing at least one insurance claim. The computer system comprises a processor, a memory storage device in communication with the processor, and a communications device. The communications device is in communication with the processor, the memory storage device and a computer communications network. The processor is configured to receive during a predetermined time period, from a user-accessible device, via the computer communications network, a data entry for addition to a transient data table, with relation to at least one insurance claim. The processor is also configured to receive during the predetermined time period, from a user-accessible device, via the computer communications network, at least one additional data entry for addition to the transient data table, with relation to at least one insurance claim. Further, the processor is configured to aggregate the data entries over the predetermined time period. Additionally, the processor is configured to freeze and record the aggregated data, relating to at least one insurance claim, upon expiration of the predetermined time period. The processor, furthermore, is configured to output the aggregated data, relating to at least one insurance claim, for viewing by a user upon expiration of the predetermined time period. Yet further, the processor is configured to repeat, at least once and over an additional predetermined time period, the receipt and aggregation of data entries and the freezing, recordation and outputting of aggregated data.

According to another aspect, the invention relates to a computer-implemented method for data recordation in processing at least one insurance claim. During a predetermined time period, there is received, from a user-accessible device, via a computer communications network, a data entry for addition to a transient data table, with relation to at least one insurance claim. Further, there is received, during the predetermined time period, from a user-accessible device, via the computer communications network, at least one additional data entry for addition to the transient data table, with relation to at least one insurance claim. Via a processor, the data entries are aggregated over the predetermined time period. Further, the aggregated data, relating to at least one insurance claim, are frozen and recorded upon expiration of the predetermined time period. Additionally, the aggregated data, relating to at least one insurance claim, are outputted for viewing by a user upon expiration of the predetermined time period. Also, there are repeated, at least once and over an additional predetermined time period, the receipt and aggregation of data entries and the freezing, recordation and outputting of aggregated data.

According to a further aspect, the invention relates to a computer system for data recordation in processing at least one financial services transaction. The computer system comprises a processor, a memory storage device in communication with the processor, and a communications device. The communications devices is in communication with the processor, the memory storage device and a computer communications network. The processor is configured to receive during a predetermined time period, from a user-accessible device, via the computer communications network, a data entry for addition to a transient data table, with relation to at least one financial services transaction. The processor is also configured to receive during the predetermined time period, from a user-accessible device, via the computer communications network, at least one additional data entry for addition to the transient data table, with relation to at least one financial services transaction. Further, the processor is configured to aggregate the data entries over the predetermined time period. Additionally, the processor is configured to freeze and record the aggregated data, relating to at least one financial services transaction, upon expiration of the predetermined time period. The processor, furthermore, is configured to output the aggregated data, relating to at least one financial services transaction, for viewing by a user upon expiration of the predetermined time period. Yet further, the processor is configured to repeat, at least once and over an additional predetermined time period, the receipt and aggregation of data entries and the freezing, recordation and outputting of aggregated data.

### BRIEF DESCRIPTION OF THE DRAWINGS

The invention may be better understood from the following illustrative description with reference to the following drawings.

FIG. 1 is a schematic diagram of a computer network, according to an illustrative embodiment of the invention.

FIG. 2 is a schematic diagram of a computer system, according to an illustrative embodiment of the invention.

FIG. 3 schematically illustrates a conventional arrangement for aggregate synchronization.

FIG. 4 schematically illustrates an arrangement for aggregate synchronization, according to an illustrative embodiment of the invention.

FIGS. 5a-b presents a detailed data table design, according to an illustrative embodiment of the invention.

FIG. 6 presents an aggregate data table design, according to an illustrative embodiment of the invention.

FIG. 7 illustrates detailed data changes during a month, according to an illustrative embodiment of the invention.

FIG. 8a provides a working example of a detailed data table and aggregate data table, according to an illustrative embodiment of the invention.

FIG. 8b provides a working example of a detailed data table containing data entered in a subsequent month, according to an illustrative embodiment of the invention.

### DESCRIPTION OF CERTAIN ILLUSTRATIVE EMBODIMENTS

As discussed herein, there are broadly contemplated herein, in accordance with at least one embodiment of the invention, methods and arrangements for readily summarizing aggregate data that relates, in some manner, to detailed data. Such data can be encountered, for instance, in a financial services and/or insurance claims setting, and can involve enormous volumes of data broken into a very large number of categories over possibly at least ten thousand data rows, or tens of thousands of data rows, or more. To the extent, then, that aggregated data are calculated and are displayed, embodiments of the invention provide for a synchronization of the aggregated data with detailed data in a manner to “snap” or freeze aggregated data after predetermined time periods and retain the same in an aggregate report as more data continue to be added over time.

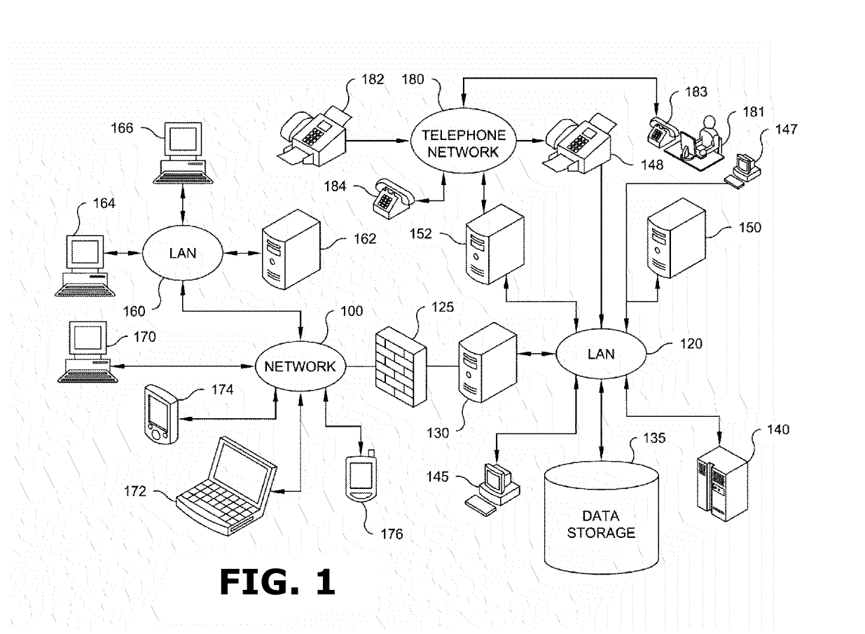

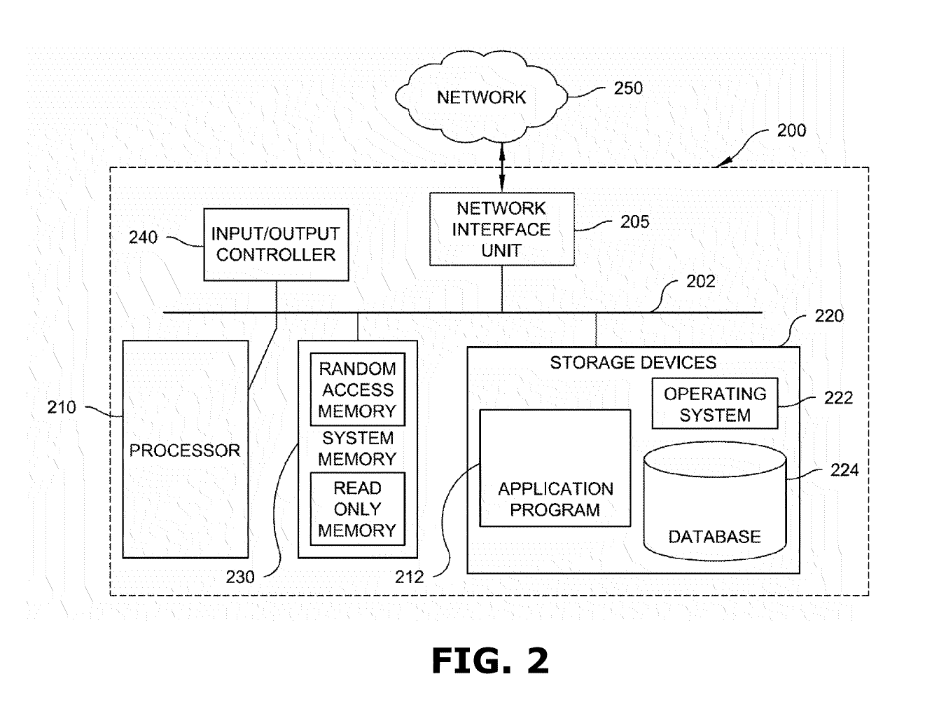

FIGS. 1 and 2 relate to examples of a computer network and computer system, respectively, which may provide a context for employing embodiments of the invention. It should be understood that the network and system shown in FIGS. 1 and 2 are provided by way of illustrative and non-restrictive example.

Referring to FIG. 1, an exemplary network configuration is shown. Network 100 connects various computer systems and devices. Network 100 may be or include any type of network, including a local area network (LAN), a wide area network (WAN), an intranet, the Internet, a public switched telephone network (PSTN) or other network. Network 100 may employ any suitable data protocols.

Various devices and networks may be in communication with network 100. In embodiments, client device 170, a desktop computer system, client device 172, a notebook computer system, client device 174, a personal digital assistant, and client device 176, a smart phone, are in communication with network 100. Client devices 170, 172, 174, 176 are merely exemplary. Local area network (LAN) 160 is an exemplary network of a business or other employer. LAN 160 has in communication therewith desktop computer systems 164, 166, and file server 162.

LAN 120 may be a network of an insurance company, by way of example. Firewall unit 125 may be configured to provide data security services with respect to systems and networks, LAN 120 and the devices in communication therewith. Firewall unit 125 may be a stand alone device including one or more processors, data storage devices, and input and output connections. Server 130 may serve as a front-end web server that formats and serves web pages to client devices running browser software. In an embodiment, a processor of server 130 may execute steps of a method of prompting users for data relating to an activity such as processing insurance claims.

In an embodiment, server 130 may function as a web front-end for another device or system, such as server 150, which may execute steps of a method of processing insurance claims. In an embodiment, either server 130 or server 150 may serve as a single point of contact for receiving data relating to an insurance claim. Mainframe computer system 140 may be a system that receives data from server 150 and performs functions related to managing and tracking insurance claims. Data storage device 135 may be in communication with LAN 120 and be accessible by server 150, mainframe computer system 140, web server 130 and other systems, for storage of and access to data related to the management and monitoring of an insurance claims process. Data storage device 135 may store data related to customers, types of insurance claims, rules regarding the same, and other salient data. Workstation 145 may be in communication via LAN 120 with data storage device 135, mainframe computer system 140, server 150, web server 130, and other devices and systems, for administrative and other functions.

In embodiments, communication between server 150 and individuals, such as employees and employers, may be via a telephone network, such as a public switched telephone network, a voice over Internet protocol network, or a combination of a PSTN and VoIP network. By way of example, a fax telephone number may be configured to receive intake data for a new leave event related to two or more categories of employee leave. Prepared forms may be available for individuals to complete with intake data. The prepared forms may serve as a structured fax format by which data may be transmitted from third party fax machine 182 via telephone network 180 to insurance company fax machine 148. Insurance company fax machine 148 may be configured to create a digital image of the received fax, e.g., in an image format such as pdf, jpg or tiff, and transmit the received digital image via LAN 120 to server 150. Server 150 may be configured to extract data from the digital image, cause the data to be stored in one or more databases, and perform analytical functions on the data. For example, server 150 may classify the data according to type of insurance claim. If the data in the received fax omits required data, contains obvious errors, or otherwise triggers a rule requiring a response, server 150 may be configured to provide an output in the form of an image file for a responsive fax and instructions to insurance company fax machine 148 to transmit a responsive fax to a telephone number corresponding to third party fax machine 182.

In an embodiment, a third party may employ voice telephone communications to an interactive voice response system (IVR) for the submission of data. Third party voice telephone 184 may be employed by a user to reach, via telephone network 180, IVR server 152. IVR server 152 may prompt the user to provide identification information via voice or keypad, and then prompt the user to provide data corresponding to required data for submission of a new insurance claim. IVR server 152 may communicate with server 150 via LAN 120. Server 150 may receive data from IVR server 152 in a suitable format. Server 150 may be configured to analyze data received from IVR server 152 during a telephone connection between IVR server 152 and third party telephone 184 and provide instructions for IVR server 152 to generate prompts for additional information, to indicate that data has been received, or to convey other information.

In embodiments, a network or data processing network, such as network 100, may be employed which may include a plurality of individual networks, such as a wireless network and a landline based network, each of which may include a plurality of servers, individual workstations or personal computers. Additionally, as those skilled in the art will appreciate, one or more LANs may be included where a LAN may comprise a plurality of intelligent workstations coupled to a host processor. The networks may also include mainframe computers or servers, such as a gateway computer or application server. A gateway computer serves as a point of entry into each network. The gateway may be preferably coupled to another network by one or more communications links. The gateway may also be directly coupled to one or more workstations using a communications link. The gateway computer may also be coupled to a storage device for storing information related to employers, employees, claims and leave policies and regulations, as well as other data. Further, the gateway may be directly or indirectly coupled to one or more workstations. Those skilled in the art will appreciate that the gateway computer may be located geographically remote from the network, and similarly, the workstations may be located geographically remote from the networks and/or network servers. The client devices or workstations may connect to the wireless network using a networking protocol such as the Transmission Control Protocol/Internet Protocol (“TCP/IP”) over a number of alternative connection media, such as cellular phone, radio frequency networks, satellite networks, etc. The wireless network may connect to the gateway using a network connection a such as TCP (Transmission Control Protocol) or UDP (User Datagram Protocol) over IP, X.25, Frame Relay, ISDN (Integrated Services Digital Network), PSTN (Public Switched Telephone Network), etc.

Referring to FIG. 2, features of a system according to an embodiment are shown. An exemplary computer system 200 for use in an implementation of the invention will now be described. In computer system 200, processor 210 executes instructions contained in programs such as an insurance claim processing program 212, stored in storage devices 220. Processor 210 may be a single processor, multiple processors, and/or one or more multiple core processors, by way of example. Storage devices 220 may include suitable media, such as optical or magnetic disks, fixed disks with magnetic storage (hard drives), tapes accessed by tape drives, and other storage media. Processor 210 communicates, such as through bus 202 and/or other data channels, with network interface unit 205, system memory 230, storage devices 220 and input/output controller 240. Via input/output controller 240, processor 210 may receive data from user inputs such as pointing devices, touch screens, audio inputs and keyboards, and may provide data to outputs, such as data to video drivers for formatting on displays, and data to audio devices for output as sound, and data to printers for printing in hard copy. Storage devices 220 are configured to exchange data with processor 210, and may store programs containing processor-executable instructions, and values of variables for use by such programs. Storage devices 220 may include local and network accessible mass storage devices. Storage devices 220 may include media for storing operating system 222 and mass storage devices such as leave related data storage 224 for storing data related to insurance claims, such as customer data, claim data, applicable rules and values of variables for compliance with regulatory requirements, benefit data, and other data.

In an embodiment, inputs may include user interfaces, including workstations having keyboards, touch screens, pointing devices such as mice, or other user input devices, connected via networked communications to processor 210. Network interface unit 205 may communicate via network 250 with remote sources of data, such as databases maintained by other systems, including computer systems for administering a single type of insurance claim, such as property or automobile insurance, and other devices, and with systems for implementing instructions output by processor 210. Systems for implementing instructions output by processor 210 may include systems for initiating communications with customers, contractors, mechanics, and others, via printing in hard copy and mailing, via postal mailing, of communications, printing to electronic files and faxing of communications, formatting and sending e-mail communication, formatting automated telephone communications, and other systems and modes of communication. Network 250 may be or include wired or wireless local area networks and wide area networks, and over communications between networks, including over the Internet. Any suitable data and communication protocols may be employed.

Broadly contemplated herein, in accordance with at least one embodiment of the invention, are processes for creating aggregate data by way of changing detailed data, wherein the detailed data can be identified for drill-down purposes, without the need to store detailed data in additional tables.

As such, it has conventionally been the case where aggregate data are created periodically from other star schemas, wherein a star schema is embodied by one or more fact tables that reference any number of dimension tables. (Dimension tables, for their part, are distinguishable from fact tables in that they contain descriptive attributes, or fields, used to group facts [e.g., product or customer facts]). Associated inefficiencies are overcome in accordance with at least one embodiment of the invention, as will be appreciated more fully herebelow.

Accordingly, in accordance with at least one embodiment of the invention, where data in rows and columns are concerned, duplicates are created of columns that are used for aggregating data within the same tables from which they originate. Such duplicates can be referred to as snapshot attributes. Both sets of columns are then kept up to date until aggregation takes place. After the aggregation process completes, the snapshot attributes are no longer updated in the originating tables. Aggregate data are then synchronized with detailed data within the snapshot attributes to facilitate any drill-downs and, in stark contrast to conventional arrangements, this is achieved without the creation of additional tables. When new aggregation is needed or desired, new snapshot columns are added to the originating tables.

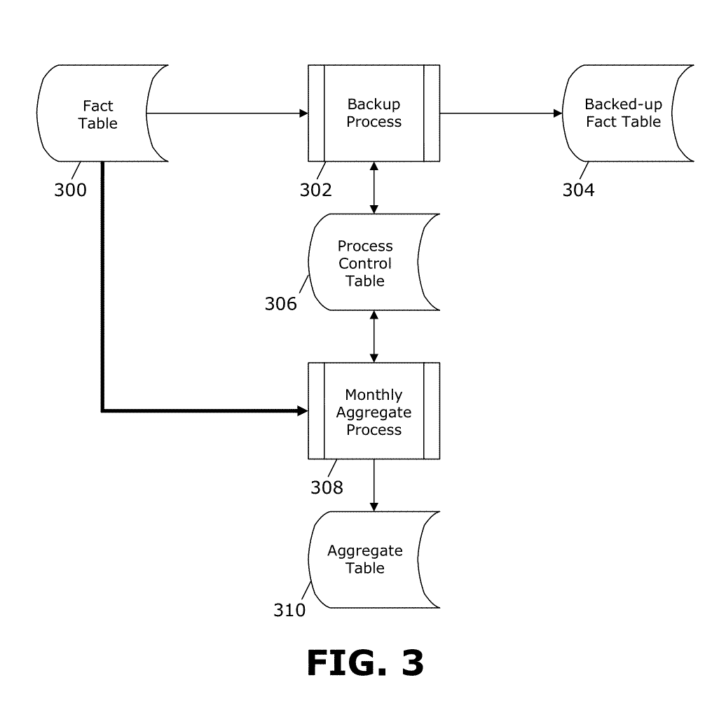

To help illustrate advantages associated with embodiments of the invention, FIG. 3 schematically illustrates a conventional arrangement for aggregate synchronization. A fact table 300 is backed up (302) to create a backed up fact table 304. Data are backed up, typically, with only selected columns back up per row or by backing up all columns. A process control table 306 governs the backup process 302 as well as a monthly aggregate process 308 that itself involves aggregating data from the fact table 300 to create an aggregate table 310.

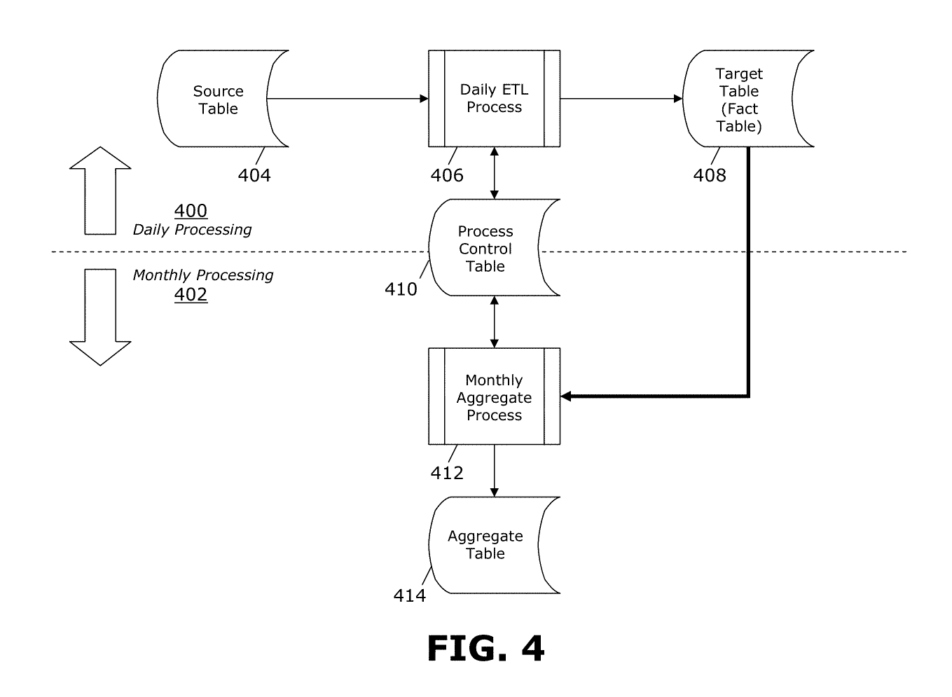

In contrast, FIG. 4 schematically illustrates an arrangement for aggregate synchronization, according to an illustrative embodiment of the invention. As shown, tasks are separately designated for daily processing (400) or monthly processing (402). Thus, in daily processing (400), source table 404 submits to a daily ETL (extract, transform, load) process 406 to create a target table (or fact table) 408. More particularly, in the daily ETL process 406 involves capturing new or changed data on a daily basis and, in a manner to be discussed in more detail herebelow, snap columns are synchronized with originating columns for current or future months.

In accordance with at least one embodiment of the invention, a process control table 410 governs the daily ETL process 406 as well as a monthly aggregate process 412. Among other elements, process control table 410 contains details about ETL jobs. The monthly aggregate process 412, for its part, involves aggregating data from the target/fact table 408 to create an aggregate table 414. More particularly, data are aggregated here using snap columns for a current reporting month.

By way of further elaboration, in accordance with at least one embodiment of the invention, in daily processing 406, a date of creation and/or submission can determine the reporting month of a data entry. Fact attributes that are to be frozen after month-end reporting are duplicated as snapshot attributes (e.g., claim status, claim amount, etc.). Prior to month-end, both fact attributes and snapshot attributes are kept in synch with data updates, while at month end (and thereafter), snapshot attributes are thence excluded from further changes (and thus are “frozen”).

In monthly processing 412, in accordance with at least one embodiment of the invention, candidate facts are selected for such processing, and can be aggregated by day and dimensional data. The aggregated facts are then stored in table 414. The process control table 410, for its part, contains details about processes, such as the name of a process and when it was last run. The process control table 410 is read by scheduled monthly processes that determine the month being processed for a current run of the process. As such, a process (for example, the monthly ETL aggregate process 412), is coded to look for specific facts and aggregate certain metrics by certain snapped columns (as defined and understood herein). Other processes, such as daily process 406, may not be coded to aggregate data and this coding, as would be conveyed by process control table 410.

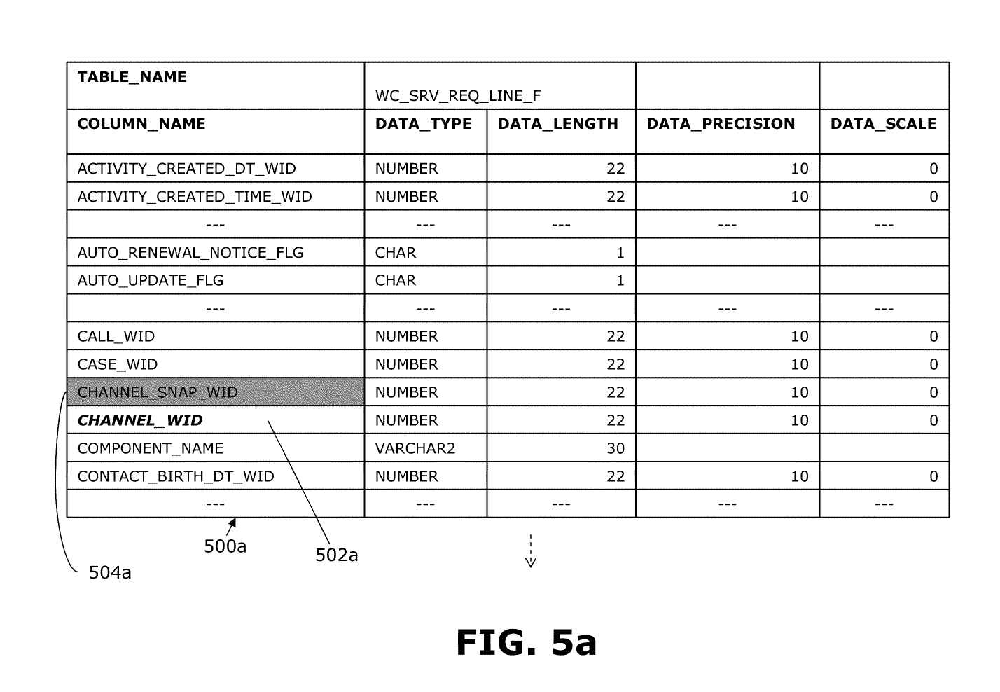

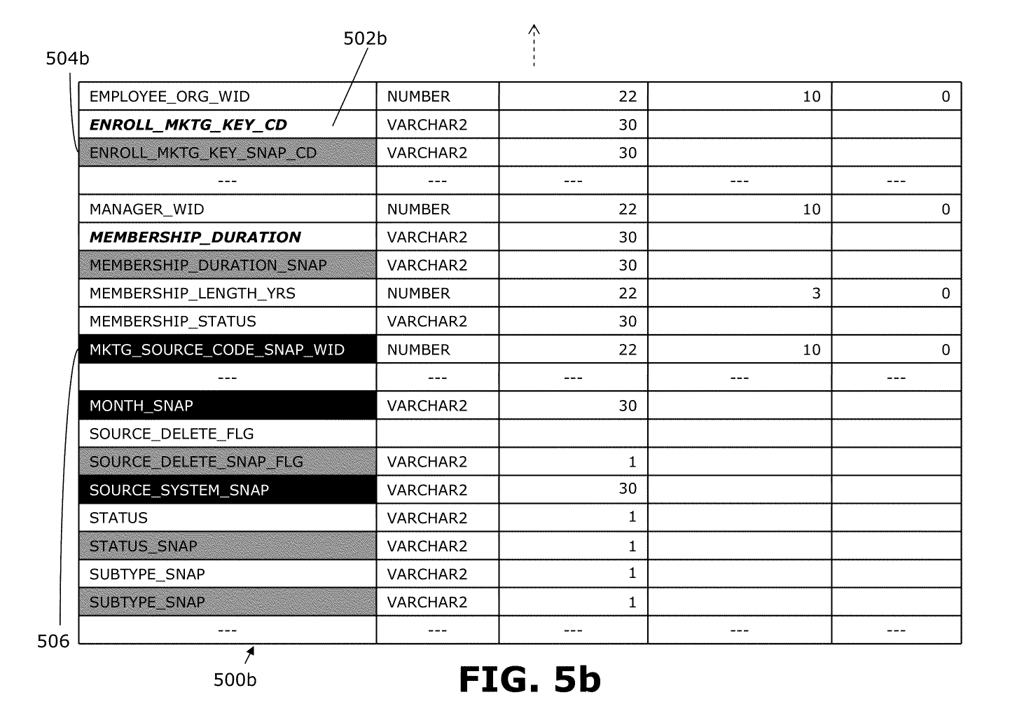

FIGS. 5a-b presents a detail data table design, according to an illustrative embodiment of the invention; both figures may now be referred to simultaneously. A first table portion 500a is shown in FIG. 5a, and a second table portion 500b is shown in FIG. 5b. To the extent that this is a detail table, column names (as labeled here) correspond to columns as found in an aggregate data table. Indicated at 502a, with bold and italicized text, is an example of a column that has an accompanying snap column, while indicated at 504a, with a grey fill, is an example of a snap column. As such, snap column 504a contains data that are frozen or snapped while the data in column 502a are changeable. Other columns analogous to 502a and 504a are indicated at 502b and 504b, respectively.

In accordance with at least one embodiment of the invention, indicated at 506, with black fill and white text, is a snap column that has does not correspond to any changeable column such as 502a or 502b. Such columns 506 can relate to data that are only entered or submitted monthly, without any intervening entries or updates being made, such as reporting month, or marketing source code. Other examples of data that could be associated with such columns 506 are names of systems or processes that are supplied with data and, thus, are not changeable within a given month or even across two or more months.

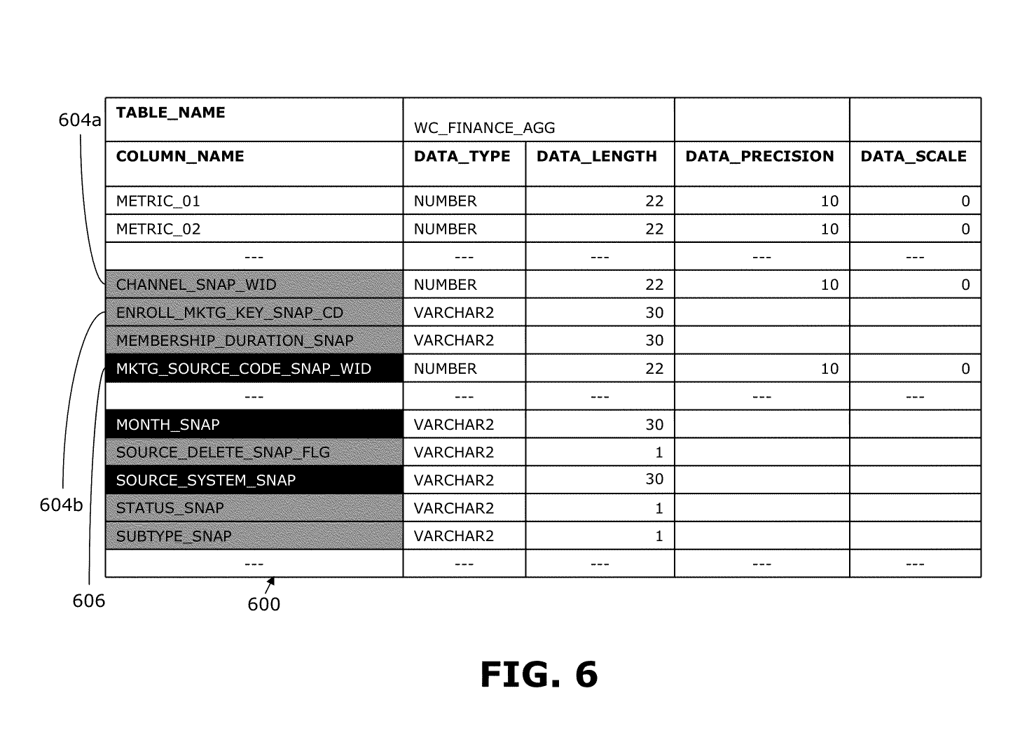

FIG. 6 presents an aggregate data table, according to an illustrative embodiment of the invention. It can now be understood that table 600 provides data from a given month. Data in snap columns 604a/604b can correspond to the snap columns 504a/504b (in the detail table of FIGS. 5a-b), and thus to data that are frozen at the end of a month. Snap columns 604a/604b can thus further correspond to the originating columns 502a/502b, that themselves contain data that are changeable within the course of a month.

In accordance with at least one embodiment of the invention, indicated at 606 is a snap column which can tie in with a column such as 506 in the aggregate table of FIGS. 5a-b, which does not correspond to any changeable column and can relate to data that are only entered or submitted month (without any intervening entries or updates being made).

Generally, in accordance with at least one embodiment of the invention as broadly described and illustrated in accordance with FIGS. 5a-6, as rows corresponding to snap columns 504a/b, 506, 604 and 606 indeed are frozen with respect to a given month, new rows corresponding to snap columns for a new month can automatically be added to each table (500a/b and 600). There need not be a cap on the number of rows that can be added to both tables.

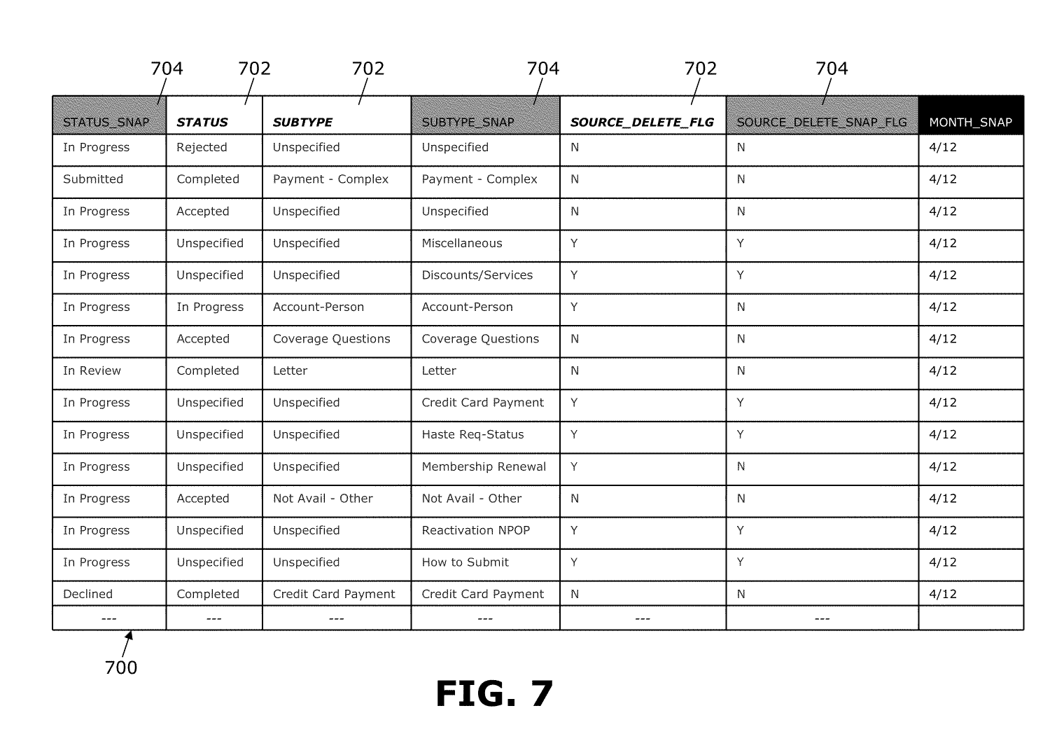

FIG. 7 presents a detail table 700, in accordance with at least one embodiment of the invention, displaying sample data values for a subset of columns described in FIGS. 5a-b. Particularly, three sets of columns indicated at 702 (originating, or changeable columns) and 704 (snap columns) show all changes made after a snapshot was taken on a given date (here, a sample date of April 12). In the present example, each snap column 704 shown here reflects data synchronized with the corresponding originating columns on April 12. Since an objective for reporting is to aggregate new data and report it in the month that it was introduced, subsequent changes to already snapped rows are not snapped again, therefore ensuring that the same data (albeit in a different state) is not reported in another month. The same cycle of capturing new data starts once the month is complete, such that once data are added in new rows to columns 702, a new corresponding snap column value (in a column 704) will be created that corresponds to data that thereafter will be accumulated.

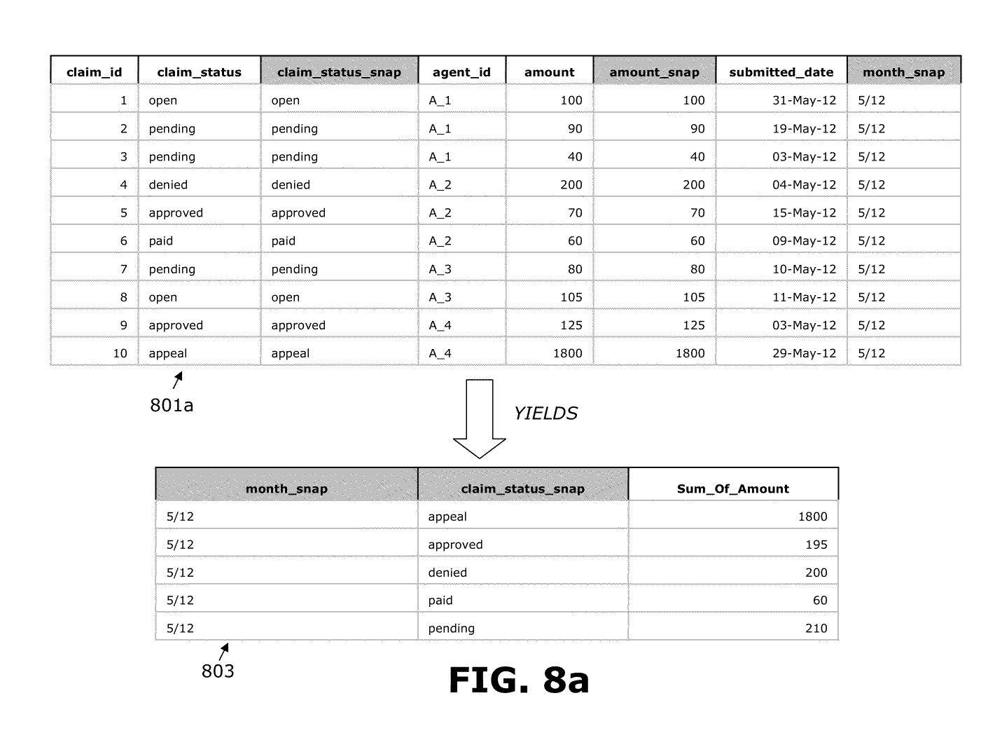

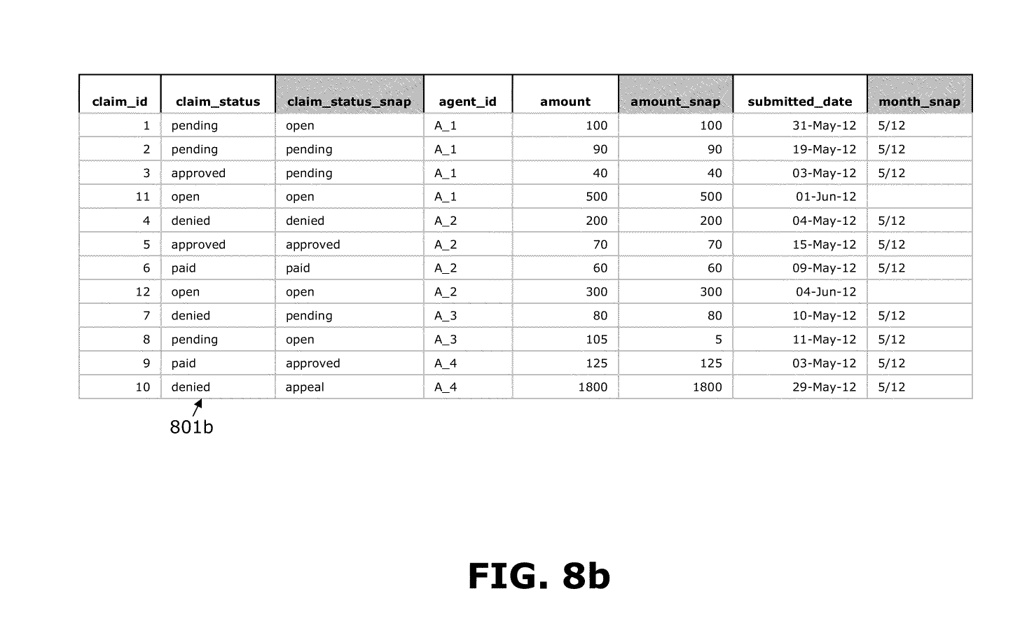

In accordance with at least one embodiment of the invention, FIG. 8a provides a working example of a detailed data table (801a) and aggregate data table (803), which are analogous in general makeup and function to the tables 700 and 600, respectively, shown in FIGS. 7 and 6. Further, FIG. 8b provides a working example of a detailed data table 801b containing data entered in a subsequent month, and thus is also analogous in general makeup and function to the table 700 shown in FIG. 7. FIGS. 8a and 8b, and the tables 801a, 803 and 801b depicted therein, relate to a common working example thus can now be referred to simultaneously.

In accordance with at least one embodiment of the invention, detailed table 801a includes originating columns (e.g., “claim status”, “amount”) and snap columns corresponding thereto (e.g., “claim status snap”, “amount snap”). Some columns (e.g., “claim id” and “agent id”) might not have corresponding snap columns, as it may be determined that such data does not need to be aggregated and snapped or frozen for a month, or does not lend itself to aggregation to begin with. In the present working example, the detailed data table 801a contains data that have been entered over the month up to May 31, 2012. On that day, aggregate table 803 is updated, and columns corresponding to May 2012 are thus “snapped” or frozen into that table 803. It can thus be appreciated that aggregate table 803 contains a subset of columns needed or desired merely for summary reporting, thereby resulting in a reduction of rows compared to the detail table 801a and enhancing reporting performance.

In accordance with at least one embodiment of the invention, the aggregate table 803 can be configured or designed as desired in accordance with ascertained reporting needs, and thus need not contain all columns that are present in the corresponding detailed table 801a. Generally, the ratio of rows between a detailed table (such as 801a) and an aggregate table (such as 803) can be significant, such as about 2:1. As such, it can be seen that, in the present working example, summations are rendered in aggregate table 803 with respect to individual types of claim status (e.g., “appeal”, “approved”, “denied”). Generally, then, it can be appreciated that aggregate table 803 can be designed or customized with respect to a particular need in connection with summary-type reporting. Particularly, columns and metrics defined in the aggregate table 803 can be configured or decided on how, e.g., an end user may consider that data need to be grouped and reported. As such, only enough columns need be selected (and employed) as may be considered to satisfy any of a potentially great variety of summary reporting needs.

In accordance with at least one embodiment of the invention, and in connection with the current working example, the data shown in FIG. 8b in detail data table 802b are current as of Jun. 10, 2012. It can now be appreciated that, by having snap columns in a detail table such as 802b, data can easily be synchronized with an aggregate table such as 803. Thus, if someone is reviewing an aggregate table 803, further examination and drill-down can be accommodated with easy reference to a corresponding detail table such as 801a or 801b.

In accordance with at least one embodiment of the invention, it should be understood and appreciated that output data from processes broadly contemplated herein can assume any of a wide variety of suitable forms. Thus, for instance, aggregate or detailed tables (e.g., such as those indicated at 803 and 801a/b, respectively, in FIGS. 8a and 8b) can appear on a computer display screen (e.g., via a suitable graphical user interface) or can be issued as a printed report.

The invention may be embodied in other specific forms without departing from the spirit or essential characteristics thereof. The forgoing embodiments are therefore to be considered in all respects illustrative, rather than limiting of the invention.

1. A computer system for data recordation in processing at least one insurance claim, comprising:
a processor;
a memory storage device in communication with the processor; and
a communications device in communication with the processor, the memory storage device and a computer communications network;
wherein the processor is configured to:
receive during a predetermined time period, from a user-accessible device, via the computer communications network, a data entry for addition to a data table, with relation to at least one insurance claim;
receive during the predetermined time period, from a user-accessible device, via the computer communications network, at least one additional data entry for updating the data table, with relation to at least one insurance claim;
create a duplicate of data in the table that is to be used for aggregating;
aggregate, via the processor, data entries over the predetermined time period;
freeze and record a copy of the data entries used for aggregating, relating to at least one insurance claim, upon expiration of the predetermined time period;
output the aggregated data, relating to at least one insurance claim, for viewing by a user upon expiration of the predetermined time period; and
after the predetermined time period, receive and update the data table, wherein the copy of the data entries used for aggregating is retained but is not updated.

2. The system according to claim 1, wherein the processor is configured to:
receive, from a user-accessible device, via the computer communications network, a single data entry for addition to the data table, with relation to at least one insurance claim, over the predetermined time period; and
record the single data entry upon expiration of the predetermined time period.

3. The system according to claim 2, wherein the processor is configured to record the single data entry in at least one of: the data table; and a cumulative table which accumulates data from a plurality of data tables.

4. The system according to claim 1, wherein the processor is configured to freeze and record the copy of data entries used for aggregating in at least one of: the data table; and a cumulative table which accumulates data from a plurality of data tables.

5. The system according to claim 1, wherein the data table is configured to store at least ten thousand rows of data.

6. The system according to claim 1, wherein the processor is configured to output the aggregated data to at least one member selected from the group consisting of: a computer display screen; and a printed report.

7. The system according to claim 1, wherein the processor is further configured to output data from the data table, relating to at least one insurance claim, for viewing by a user during the predetermined time period.

8. A computer-implemented method for data recordation in processing at least one insurance claim, comprising:
receiving during a predetermined time period, from a user-accessible device, via a computer communications network, a data entry for addition to a data table, with relation to at least one insurance claim;
receiving during the predetermined time period, from a user-accessible device, via the computer communications network, at least one additional data entry for updating the data table, with relation to at least one insurance claim;
creating, using a processor, a duplicate of data in the table that is to be used for aggregating;
aggregating, via a processor, data entries over the predetermined time period;
freezing and recording in a memory, a copy of the data entries used for aggregating, relating to at least one insurance claim, upon expiration of the predetermined time period;
outputting the aggregated data, relating to at least one insurance claim, for viewing by a user upon expiration of the predetermined time period; and
after the predetermined time period, receiving and updating the data in the table, wherein the copy of the data entries used for aggregating is retained but is not updated.

9. The computer-implemented method according to claim 8, further comprising:
receiving, from a user-accessible device, via the computer communications network, a single data entry for addition to the data table, with relation to at least one insurance claim, over the predetermined time period; and
recording the single data entry upon expiration of the predetermined time period.

10. The computer-implemented method according to claim 9, wherein the recording of the single data entry comprises recording the single data entry in at least one of: the data table; and a cumulative table which accumulates data from a plurality of data tables.

11. The computer-implemented method according to claim 8, wherein the freezing and recording comprises freezing and recording the copy of data entries used for aggregating in at least one of: the data table; and a cumulative table which accumulates data from a plurality of data tables.

12. The computer-implemented method according to claim 8, wherein the data table is configured to store at least ten thousand rows of data.

13. The computer-implemented method according to claim 8, wherein the outputting comprises outputting the aggregated data to at least one member selected from the group consisting of: a computer display screen; and a printed report.

14. The computer-implemented method according to claim 8, further comprising outputting data from the data table, relating to at least one insurance claim, for viewing by a user during the predetermined time period.

15. A computer system for data recordation in processing at least one financial services transaction, comprising:
a processor;
a memory storage device in communication with the processor; and
a communications device in communication with the processor, the memory storage device and a computer communications network;
wherein the processor is configured to:
receive during a predetermined time period, from a user-accessible device, via the computer communications network, a data entry for addition to a data table, with relation to at least one financial services transaction;
receive during the predetermined time period, from a user-accessible device, via the computer communications network, at least one additional data entry for updating the data table, with relation to at least one financial services transaction;
create a duplicate of data in the table that is to be used for aggregating;
aggregate, via the processor, data entries over the predetermined time period;
freeze and record a copy of the data entries used for aggregating, relating to at least one financial services transaction, upon expiration of the predetermined time period;
output the aggregated data, relating to at least one financial services transaction, for viewing by a user upon expiration of the predetermined time period; and
after the predetermined time period, receive and update the data table, wherein the copy of the data entries used for aggregating is retained but is not updated.

16. The system according to claim 15, wherein the processor is configured to:
receive, from a user-accessible device, via the computer communications network, a single data entry for addition to the data table, with relation to at least one financial services transaction, over the predetermined time period; and
record the single data entry upon expiration of the predetermined time period.

17. The system according to claim 16, wherein the processor is configured to record the single data entry in at least one of: the data table; and a cumulative table which accumulates data from a plurality of data tables.

18. The system according to claim 15, wherein the processor is configured to freeze and record the aggregated data in at least one of: the data table; and a cumulative table which accumulates data from a plurality of data tables.

19. The system according to claim 15, wherein the data table is configured to store at least ten thousand rows of data.

20. The system according to claim 15, wherein the processor is further configured to output data from the data table, relating to at least one financial services transaction, for viewing by a user during the predetermined time period.
